(19) United States
(12) Patent Application Publication
(10) Pub. No.: US 2020/0060008 A1
(43) Pub. Date: Feb. 20, 2020

(54) LIGHTING CONTROLLER AND LIGHTING CONTROL METHOD

(71) Applicant: PANASONIC INTELLECTUAL PROPERTY MANAGEMENT CO., LTD., Osaka (JP)

(72) Inventor: Koji HOSHI, Osaka (JP)

(21) Appl. No.: 16/544,624

(22) Filed: Aug. 19, 2019

(30) Foreign Application Priority Data
Aug. 20, 2018 (JP) 2018-154179

(51) Int. Cl. H05B 37/02

(52) U.S. Cl. CPC H05B 37/0254

(57) ABSTRACT

The time required for the state monitoring can be shortened when there is a lighting fixture which has been turned off. A lighting controller for controlling lighting fixtures includes: a memory; and a processor coupled to the memory. The processor identifies a first lighting fixture connected to a first power supply system, identifies a second lighting fixture connected to a second power supply system, and gives a lower priority to control of the second lighting fixture than to control of the first lighting fixture, if the processor receives a response to an interrogation, which is sent from the processor to the first lighting fixture, from the first lighting fixture within a predetermined period of time, and does not receive a response to an interrogation, which is sent from the processor to the second lighting fixture, from the second lighting fixture within the predetermined period of time.

### CROSS-REFERENCE TO RELATED APPLICATION

This application claims priority to Japanese Patent Application No. 2018-154179 filed on Aug. 20, 2018, the entire disclosure of which is incorporated by reference herein.

### BACKGROUND

The present disclosure relates to a lighting controller for controlling lighting fixtures and a method for controlling the lighting fixtures.

A large-scale lighting system providing constant monitoring includes a controller which periodically interrogates a target lighting fixture, and the target lighting fixture sends a response about the state of itself within a specified period of time. That is, a typical state monitoring in a steady state employs a polling system in which a controller, serving as a master, interrogates lighting fixtures in a fixed order. The system detects that a fixture has been turned off and disconnected from the system, based on a response timeout. However, such a timeout generally takes a long time due to a slow transmission speed and a slow response from the lighting fixture.

### SUMMARY

There are many cases in which even the lighting fixtures monitored by the same controller are connected to different power supply systems. The present inventors have realized that in such a case if some or more of the fixtures are turned off together, the state monitoring takes a long time.

According to an embodiment, a lighting controller for controlling lighting fixtures includes: a memory; and a processor coupled to the memory. The processor identifies a first lighting fixture connected to a first power supply system, identifies a second lighting fixture connected to a second power supply system, and gives a lower priority to control of the second lighting fixture than to control of the first lighting fixture, if the processor receives a response to an interrogation, which is sent from the processor to the first lighting fixture, from the first lighting fixture within a predetermined period of time, and does not receive a response to an interrogation, which is sent from the processor to the second lighting fixture, from the second lighting fixture within the predetermined period of time.

According to an embodiment, a method for controlling lighting of lighting fixtures includes: identifying a first lighting fixture connected to a first power supply system; identifying a second lighting fixture connected to a second power supply system; and giving a lower priority to control of the second lighting fixture than to control of the first lighting fixture, if the processor receives a response to an interrogation, which is sent from the processor to the first lighting fixture, from the first lighting fixture within a predetermined period of time, and does not receive a response to an interrogation, which is sent from the processor to the second lighting fixture, from the second lighting fixture within the predetermined period of time.

The time required for the state monitoring can be shortened when there is a lighting fixture which has been turned off.

### BRIEF DESCRIPTION OF THE DRAWINGS

FIG. 1 is a block diagram of a lighting system.

FIG. 2 is a flowchart showing an algorithm for recording power supply systems.

FIG. 3 is a flowchart showing an algorithm for providing state monitoring in a steady state.

FIG. 4 is a block diagram of buffers in a normal state, which are used for prioritization.

FIG. 5 is a block diagram of the buffers used to provide individual prioritization in a non-normal state.

FIG. 6 is a block diagram of the buffers used to provide group prioritization in a non-normal state.

### DETAILED DESCRIPTION

Hardware

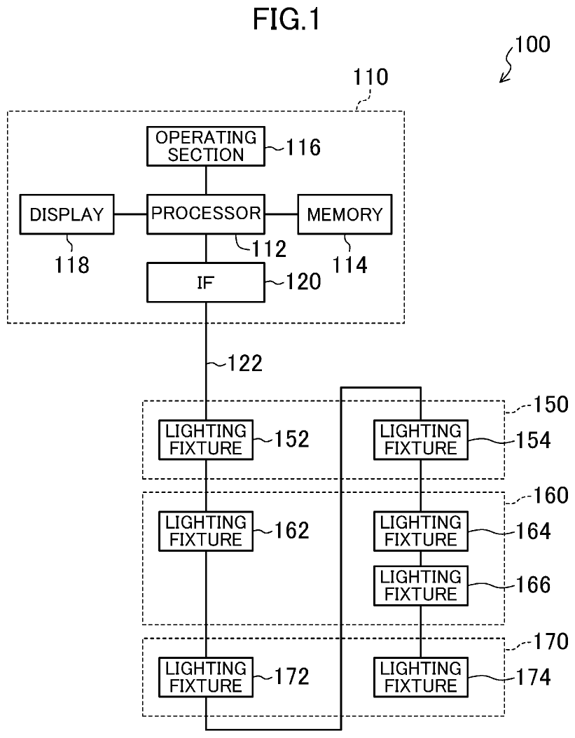

FIG. 1 is a block diagram of a lighting system 100. The lighting system 100 includes a lighting controller 110, and lighting fixtures 152, 154, 162, 164, 166, 172, and 174.

The lighting controller 110 includes a processor 112, a memory 114, an operating section 116, a display 118, and an interface (IF) 120. The memory 114 stores a program for executing a control method according to the present disclosure. The processor 112 reads and executes the program. The operating section 116 receives a command from a user of the lighting system 100, and transmits the command to the lighting controller 110. The display 118 shows the states and other information of the lighting controller 110 and the lighting fixtures 152, 154, 162, 164, 166, 172, and 174 for the user. The interface 120 outputs a lighting control signal, which is output from the processor 112, to a communication line 122. The lighting controller 110 includes the operating section 116 and the display 118, typically as a man-machine interface (MMI), and functions as a monitor for the lighting fixtures. The display 118 may be a touch panel functioning also as the operating section 116.

The lighting fixtures 152, 154, 162, 164, 166, 172, and 174 are serially coupled to the lighting controller 110 through the communication line 122. The lighting controller 110 controls the on/off state, brightness, and other parameters of the lighting fixtures 152, 154, 162, 164, 166, 172, and 174 via the communication line 122. The communication line 122 transmits packets between the lighting controller 110 and the lighting fixtures 152, 154, 162, 164, 166, 172, and 174 to attain bi-directional serial communication. The communication line 122 includes, for example, two metal wires. The serial communication standards are, for example, RS-232C and RS-485. The lighting fixtures 152, 154, 162, 164, 166, 172, and 174 change their on/off state, brightness, and other parameters, based on control information included in the associated packets transmitted from the lighting controller 110 via the communication line 122.

The lighting fixtures 152 and 154 are connected to a power supply system 150. The lighting fixtures 162, 164, and 166 are connected to a power supply system 160. The lighting fixtures 172 and 174 are connected to a power supply system 170. The power supply systems 150, 160, and 170 are independent of one another. The power supply systems may also be referred to as power supply units. Unless broken or in any other abnormal situation, the power supply systems 150, 160, and 170 connected to the lighting fixtures 152 and 154, the lighting fixtures 162, 164, and 166, and the lighting fixtures 172, and 174, respectively, are capable of steadily supplying electric power to the associated ones of the lighting fixtures 152, 154, 162, 164, 166, 172, and 174. The voltage of the power supply systems 150, 160, and 170 is, for example, 200 volts AC, but is not limited thereto as long as a suitable voltage is supplied to the lighting fixtures 152, 154, 162, 164, 166, 172, and 174.

The number of lighting fixtures to be controlled by the lighting controller 110 should not be limited to the number of the lighting fixtures shown, and is optional. The number of lighting fixtures connected to each of the power supply systems 150, 160, and 170 should not be limited to the number of the lighting fixtures shown, and is optional. The number of power supply systems for supplying power to the lighting fixtures 152, 154, 162, 164, 166, 172, and 174 should not be limited to the number of the power supply systems shown, and is optional. The number of communication lines connected to the lighting controller 110 should not be limited to the number of the communication line shown, and is optional.

Recording of Power Supply Systems

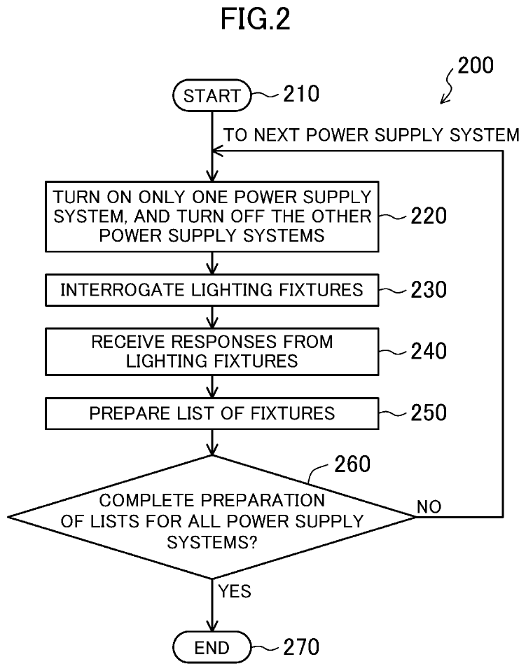

FIG. 2 is a flowchart showing an algorithm 200 for recording power supply systems. The recording of power supply systems means preparation of a list of fixtures indicating which of the lighting fixtures is/are connected to the respective power supply systems 150, 160, and 170.

In step 210, the lighting controller 110 starts the recording of the power supply systems. The algorithm 200 is executed at the installation of the lighting system 100 in a typical case. However, when to execute the algorithm 200 is not limited thereto, and the algorithm 200 may be executed at any timing. For example, a user of the lighting system 100 gives a command to start recording the power supply systems to lighting controller 110 via the operating section 116 at the installation of the system.

In step 220, the lighting controller 110 turns on one of the power supply systems 150, 160, and 170 first (e.g., turns on the power supply system 150 first) and then turns off the other power supply systems 160 and 170.

In step 230, the lighting controller 110 interrogates the lighting fixtures 152, 154, 162, 164, 166, 172, and 174. Specifically, the lighting controller 110 sends a packet (an “interrogation packet”) indicating an interrogation to the lighting fixtures 152, 154, 162, 164, 166, 172, and 174. Upon receipt of the interrogation packet from the lighting controller 110, each of the lighting fixtures 152, 154, 162, 164, 166, 172, and 174 sends a packet (a “response packet”) indicating a response to the lighting controller 110.

In step 240, the lighting controller 110 waits for a predetermined period of time to receive the response packets from the lighting fixtures 152 and 154. In this example, only the power supply system 150 is turned on. Thus, the response packet is sent back from the lighting fixtures connected to the power supply system 150, whereas the response packets are not sent back from the lighting fixtures not connected to the power supply system 150. This configuration allows the lighting controller 110 which has received the response packets from the lighting fixtures 152 and 154 to determine that the lighting fixtures 152 and 154 are connected to the power supply system 150.

In step 250, the lighting controller 110 prepares a list of fixtures indicating which of the lighting fixtures is/are connected to each power supply system. The list of fixtures indicates, for example, that the lighting fixtures 152 and 154 are connected to the power supply system 150. The list of fixtures may be any suitable data structure, and is stored, for example, in the memory 114.

In step 260, it is determined whether the lists of fixtures for all of the power supply systems have been prepared or not. When the lists of fixtures for all of the power supply systems have been prepared, the control process proceeds to step 270 via “YES” and ends.

If the lists of fixtures for all of the power supply systems have not been prepared, the control process returns to step 220 via “NO”. In this case, in step 220, a power supply system (e.g., the power supply system 160), other than the power supply system (e.g., the power supply system 150) on which the list of fixtures has already been prepared, is selected and turned on, and the other power supply systems 150 and 170 are turned off.

In step 270, the lighting controller 110 prepares the lists of fixtures identifying the lighting fixtures connected to the respective power supply systems 150, 160, and 170, and stores the lists of fixtures in the memory 114, for example. The list of fixtures may be data in a table format, for example. Such a table is used to associate the power supply system 150 with the lighting fixtures 152 and 154, the power supply system 160 with the lighting fixtures 162, 164, and 166, and the power supply system 170 with the lighting fixtures 172 and 174. This configuration allows the lighting controller 110 to identify the connection relationship between the lighting fixtures and the power supply systems in the initial state, and hold the information about the connection relationship. To identify the lighting fixtures, the serial numbers of the lighting fixtures are used, for example.

State Monitoring in Steady State

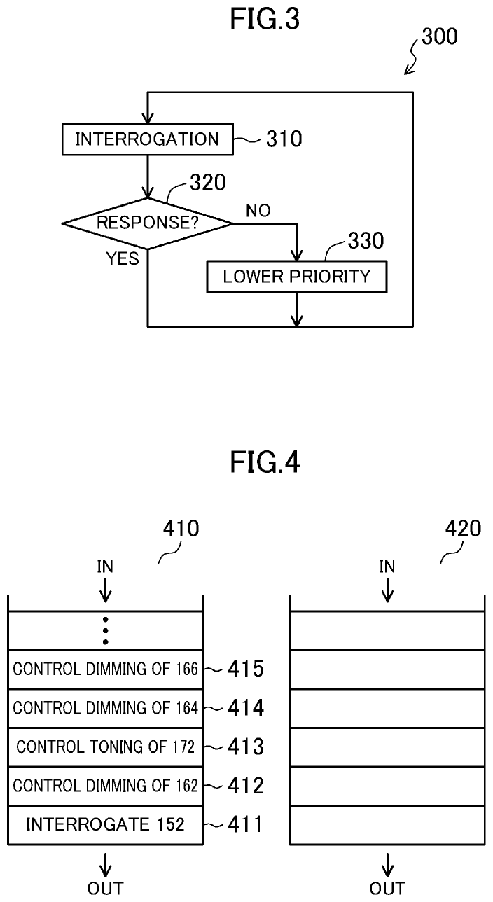

FIG. 3 is a flowchart showing an algorithm 300 for providing state monitoring in a steady state. The algorithm 300 is typically executed after the completion of the algorithm 200. The algorithm 300 may be iteratively executed at appropriate intervals using a timer or any other devices.

In step 310, the lighting controller 110 interrogates the lighting fixtures 152, 154, 162, 164, 166, 172, and 174 sequentially one by one. Assume that all of the power supply systems 150, 160, and 170 are turned on. In such a case, responses should be received from all of the lighting fixtures.

In step 320, the lighting controller 110 waits for a predetermined period of time to receive the response packets from the lighting fixtures, and determines whether responses are sent from all of the lighting fixtures or not. If the lighting controller 110 receives responses from all of the lighting fixtures, the control process returns to step 310 via YES. If responses are no received from some of the lighting fixtures, the control process proceeds to step 330 via NO. The receipt of a response from a lighting fixture may also be referred to as the existence of the lighting fixture. The absence of a response from a lighting fixture may also be referred to as the disconnection of the lighting fixture.

In step 330, the lighting controller 110 gives a lower priority to the control of the lighting fixture from which no response is received (i.e., “individual prioritization”). For example, if a response is not received only from the lighting fixture 162, the lighting controller 110 gives a lower priority to the control of the lighting fixture 162 than to the control of the other lighting fixtures. The lighting controller 110 serially sends packets to the lighting fixtures to control the lighting fixtures. In a case of a large number of lighting fixtures, the time cost for sending packets to those lighting fixtures from which no response is received is not ignorable. Thus, giving a lower priority to the control of the lighting fixture from which no response is received allows the other lighting fixtures to be controlled in a more timely manner. According to the individual prioritization, only the lighting fixture from which no response is received can be selected to, for example, postpone the control of that lighting fixture, which may contribute to efficient control.

In step 330, according to another embodiment, the lighting controller 110 gives a lower priority to the control of all of the lighting fixtures connected to the power supply system to which the lighting fixture from which no response is received is connected (i.e., “group prioritization”). For example, if a response is not received only from the lighting fixture 162, the lighting controller 110 gives a lower priority to the control of all of the lighting fixtures 162, 164, and 166 connected to the power supply system 160 to which the lighting fixture 162 is connected, than to the control of the other lighting fixtures.

In the group prioritization, if no response is received from a certain lighting fixture, the power supply system to which the certain lighting fixture is connected is assumed not to operate, and a lower priority is given to the control of all of the lighting fixtures connected to the power supply system. Under this assumption, if no response is received from the lighting fixture 162, interrogations for the other lighting fixtures 164 and 166 connected to the power supply system 160 to which the lighting fixture 162 can be omitted. This means that the interrogations and control for all of the lighting fixtures (e.g., 162, 164, and 166) connected to the power supply system (e.g., 160) that has been assumed not to operate can be omitted. The group prioritization may thus contribute to more efficient control, compared with the individual prioritization.

Prioritization

FIG. 4 is a block diagram of buffers 410 and 420 in a normal state. The buffers 410 and 420 are used for prioritization. Commands 411 to 415 are a command to interrogate the lighting fixture 152, a command to control dimming of the lighting fixture 162, a command to control toning of the lighting fixture 172, a command to control dimming of the lighting fixture 164, and a command to control dimming of the lighting fixture 166, respectively. The dimming control is intended to determine the brightness of the target lighting fixture. The toning control is intended to determine the hue of the target lighting fixture. The dimming control and the toning control are performed to adapt to settings input by the user through the operating section 116, for example.

The buffers 410 and 420 are typically first-in first-out (FIFO) buffers. The buffers 410 and 420 are provided, for example, in the memory 114, and are controlled by the processor 112. The processor 112 stores commands with a higher priority in the buffer 410, and stores commands with a lower priority in the buffer 420. The processor 112 preferentially processes the commands stored in the buffer 410, and does not preferentially process the commands stored in the buffer 420. In an example, the processor 112 processes the commands stored in the buffer 420 after the processor 112 has processed the commands stored in the buffer 410. In another example, the processor 112 prioritizes the commands such that the commands in the buffer 410 are more frequently executed than the commands in the buffer 420.

The normal state refers to a state in which responses are received from all of the lighting fixtures 152, 154, 162, 164, 166, 172, and 174. Whether the system is in the normal state or the non-normal state (which will be described later) may be recognized by the periodical interrogations from the processor 112 to the lighting fixtures. In the normal state, the commands for all of the lighting fixtures are stored in the buffer 410 without prioritization. In other words, the processor 112 stores all the commands (here, the commands 411 to 415) in the buffer 410 alone, and does not store the commands in the buffer 420. Since, in the normal state, the commands for all of the lighting fixtures are stored in the buffer 410, no difference in operation is observed between the individual prioritization and the group prioritization.

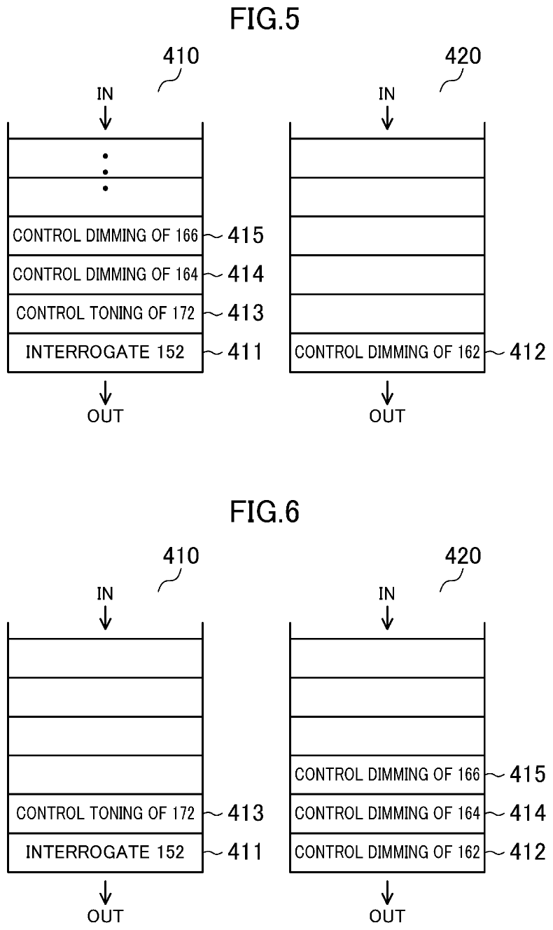

FIG. 5 is a block diagram of the buffers 410 and 420 used to provide individual prioritization in a non-normal state. The non-normal state refers to a state in which a response is not received from at least one of the lighting fixtures 152, 154, 162, 164, 166, 172, and 174. In an example, if a response is not received only from the lighting fixture 162, only the command 412 for the lighting fixture 162 is stored in the buffer 420, and the commands 411, 413, 414, and 415 for the other lighting fixtures from which the responses are received are stored in the buffer 410. This configuration achieves efficient control because the commands stored in the buffer 410 are more preferentially executed than the commands stored in the buffer 420.

FIG. 6 is a block diagram of the buffers 410 and 420 used to provide group prioritization in a non-normal state. In an example, if a response is not received only from the lighting fixture 162, the commands 412, 414, and 415 for the lighting fixtures 162, 164, and 166 connected to the power supply system 160 to which the lighting fixture 162 is connected are stored in the buffer 420, and the commands 411 and 413 for the other lighting fixtures are stored in the buffer 410. This configuration achieves efficient control because the commands stored in the buffer 410 are more preferentially executed than the commands stored in the buffer 420. The greater the number of lighting fixtures connected to a certain power supply system is, the more effective the group prioritization is.

A subject matter of the device, system, or method according to the present disclosure includes a computer. The computer executes the program to implement the functions of the main component of the device, system, or method according to the present disclosure. The computer includes, as a main hardware configuration, a processor that operates according to a program. The type of the processor is not limited as long as the processor can execute the program to implement the functions. The processor is configured as one or more electronic circuits including a semiconductor integrated circuit (IC) or a large scale integration (LSI). The processor is herein referred to as an IC or an LSI. However, the name of the processor may vary depending on the degree of integration of the processor, and a processor referred to as a system LSI, a very large scale integration (VLSI), or an ultra large scale integration (ULSI) may also be used as the processor. A field-programmable gate array (FPGA) programmable after manufacturing of an LSI, or a reconfigurable logic device capable of reconfiguring the junction relationship inside an LSI or of setting up a circuit partition inside the LSI can also be used for the same purpose. The electronic circuits may be integrated on a single chip, or may be provided on a plurality of chips. The chips may converge into a single device, or may be provided for a plurality of devices. The program is recorded in a computer-readable, non-transitory recording medium, such as a ROM, an optical disk, and a hard disk drive. The program may be stored in the recording medium in advance, or may be supplied to the recording medium via a wide area communication network including the Internet.

What has been described above includes various examples of the present invention. It is, of course, not possible to describe every conceivable combination of the components and/or methodologies for the purpose of describing the present invention, but one of ordinary skill in the art may recognize that many further combinations and permutations of the present invention are possible. Accordingly, the present invention is intended to embrace all such alternations, modifications and variations that fall within the spirit and scope of the appended claims.

What is claimed is:

1. A lighting controller for controlling lighting fixtures, the lighting controller comprising:
a memory; and
a processor coupled to the memory, wherein
the processor
identifies a first lighting fixture connected to a first power supply system,
identifies a second lighting fixture connected to a second power supply system, and
gives a lower priority to control of the second lighting fixture than to control of the first lighting fixture, if the processor receives a response to an interrogation, which is sent from the processor to the first lighting fixture, from the first lighting fixture within a predetermined period of time, and does not receive a response to an interrogation, which is sent from the processor to the second lighting fixture, from the second lighting fixture within the predetermined period of time.

2. The lighting controller of claim 1, wherein
the processor gives a lower priority to the control of the second lighting fixture connected to the second power supply system than to the control of the first lighting fixture.

3. The lighting controller of claim 1, wherein
the processor
stores a command to control the first lighting fixture in a first buffer,
stores a command to control the second lighting fixture in a second buffer, and
reads the command from the first buffer more preferentially than reading the command from the second buffer.

4. A lighting system comprising:
the lighting controller according to claim 1; and
at least one lighting fixture.

5. A method for controlling lighting of lighting fixtures, the method comprising:
identifying a first lighting fixture connected to a first power supply system;
identifying a second lighting fixture connected to a second power supply system; and
giving a lower priority to control of the second lighting fixture than to control of the first lighting fixture, if the processor receives a response to an interrogation, which is sent from the processor to the first lighting fixture, from the first lighting fixture within a predetermined period of time, and does not receive a response to an interrogation, which is sent from the processor to the second lighting fixture, from the second lighting fixture within the predetermined period of time.
